(19) United States
(12) Patent Application Publication
(10) Pub. No.: US 2026/0037748 A1
(43) Pub. Date: Feb. 5, 2026

(54) LLM prompt with decoy categories

(71) Applicant: PALO ALTO NETWORKS (ISRAEL ANALYTICS) LTD., Tel Aviv (IL)

(72) Inventors: Yohan Hai Guez, Tel Aviv (IL); Guy Holdengreber, Tel Aviv (IL); Lior Perry, Beer Sheva (IL)

(21) Appl. No.: 18/791,505

(22) Filed: Aug. 1, 2024

(51) Int. Cl. G06F 40/40

(52) U.S. Cl. CPC G06F 40/40

(57) ABSTRACT

In one embodiment, a device includes a processor configured to execute a software application to populate a large language model (LLM) prompt template yielding a populated LLM prompt including a categorical question for an LLM to perform a categorization task, the categorical question including given categories and decoy categories, provide the populated LLM prompt as input to the LLM, and receive a text response from the LLM based on processing the populated LLM prompt as input, the text response of the LLM including a categorical answer indicating one of the given categories or one of the decoy categories, and a memory to store data used by the processor.

### FIELD OF THE DISCLOSURE

The present disclosure relates to computer systems, and in particular, but not exclusively to, large language model (LLM) prompts.

### BACKGROUND

A large language model is a deep learning algorithm that can perform a variety of natural language processing tasks. Large language models generally use transformer models and are trained using huge datasets. Once an LLM has been trained, the LLM may be queried with a prompt to generate a response, which could be an answer to a question, newly generated text, summarized text, or a sentiment analysis report. Among the most common uses for an LLM is via a chatbot where a user interacts in a query-response model.

As previously mentioned, a transformer model is the most common architecture of a large language model. Transformer models work with self-attention mechanisms, which enables models to learn more quickly than traditional models like long short-term memory models. Self-attention is what enables the transformer model to consider different parts of the sequence, or the entire context of a sentence, to generate predictions.

Large language models do have disadvantages. For example, large language models may hallucinate and produce an output that is false, or that does not match the user's intent.

### SUMMARY

There is provided in accordance with an embodiment of the present disclosure, a device, including a processor configured to execute a software application to populate a large language model (LLM) prompt template yielding a populated LLM prompt including a categorical question for an LLM to perform a categorization task, the categorical question including given categories and decoy categories, provide the populated LLM prompt as input to the LLM, and receive a text response from the LLM based on processing the populated LLM prompt as input, the text response of the LLM including a categorical answer indicating one of the given categories or one of the decoy categories, and a memory to store data used by the processor.

Further in accordance with an embodiment of the present disclosure the software application is configured to perform a category-specific operation based on any one of the given categories being selected by the LLM, and not perform a category-specific operation based on any one of the decoy categories being selected by the LLM.

Still further in accordance with an embodiment of the present disclosure inclusion of the decoy categories in the populated LLM prompt causes the LLM to avoid spuriously selecting one of the given categories.

Additionally in accordance with an embodiment of the present disclosure the given categories are categories that are supported by the software application, and the decoy categories are categories that are unsupported by the software application.

Moreover, in accordance with an embodiment of the present disclosure the software application is configured to respond indicating that a request is unsupported based on any one of the decoy categories being included in the text response of the LLM.

Further in accordance with an embodiment of the present disclosure the software application is configured to respond indicating that a language of a request is unsupported based on any one of the decoy categories being included in the text response of the LLM.

Still further in accordance with an embodiment of the present disclosure the given categories are languages that are supported by the software application and the decoy categories are languages that are unsupported by the software application.

Additionally in accordance with an embodiment of the present disclosure the given categories are supported Application Programming Interfaces (APIs), and the decoy categories are unsupported APIs.

Moreover, in accordance with an embodiment of the present disclosure the categorical answer indicates one of the given categories of a given API of the supported APIs, and the software application is configured to call the given API.

There is also provided in accordance with another embodiment of the present disclosure, a method, including populating a large language model (LLM) prompt template yielding a populated LLM prompt including a categorical question for an LLM to perform a categorization task, the categorical question including given categories and decoy categories, providing the populated LLM prompt as input to the LLM, and receiving a text response from the LLM based on processing the populated LLM prompt as input, the text response of the LLM including a categorical answer indicating one of the given categories or one of the decoy categories.

Further in accordance with an embodiment of the present disclosure, the method includes performing a category-specific operation based on any one of the given categories being selected by the LLM, and not performing a category-specific operation based on any one of the decoy categories being selected by the LLM.

Still further in accordance with an embodiment of the present disclosure inclusion of the decoy categories in the populated LLM prompt causes the LLM to avoid spuriously selecting one of the given categories.

Additionally in accordance with an embodiment of the present disclosure the given categories are categories that are supported by a software application, and the decoy categories are categories that are unsupported by the software application.

Moreover, in accordance with an embodiment of the present disclosure, the method includes responding indicating that a request is unsupported based on any one of the decoy categories being included in the text response of the LLM.

Further in accordance with an embodiment of the present disclosure, the method includes responding indicating that a language of a request is unsupported based on any one of the decoy categories being included in the text response of the LLM.

Still further in accordance with an embodiment of the present disclosure the given categories are languages that are supported by the software application and the decoy categories are languages that are unsupported by the software application.

Additionally in accordance with an embodiment of the present disclosure the given categories are supported Application Programming Interfaces (APIs), and the decoy categories are unsupported APIs.

Moreover, in accordance with an embodiment of the present disclosure the categorical answer indicates one of the given categories of a given API of the supported APIs, the method further including calling the given API.

There is also provided in accordance with still another embodiment of the present disclosure, a software product, including a non-transient computer-readable medium in which program instructions are stored, which instructions, when read by a central processing unit (CPU), cause the CPU to populate a large language model (LLM) prompt template yielding a populated LLM prompt including a categorical question for an LLM to perform a categorization task, the categorical question including given categories and decoy categories, provide the populated LLM prompt as input to the LLM, and receive a text response from the LLM based on processing the populated LLM prompt as input, the text response of the LLM including a categorical answer indicating one of the given categories or one of the decoy categories.

### BRIEF DESCRIPTION OF THE DRAWINGS

The present disclosure will be understood from the following detailed description, taken in conjunction with the drawings in which:

FIG. 1 is a partly pictorial, partly block diagram view of an LLM-based computer system constructed and operative in accordance with an embodiment of the present disclosure;

FIG. 2 is a flowchart including steps in a method of operation for use in the system of FIG. 1;

FIG. 3 is a schematic view illustrating population of an LLM prompt template for use in the system of FIG. 1;

FIG. 4 is a partly pictorial, partly block diagram view of the LLM-based computer system of FIG. 1 processing a text response from an LLM; and

FIGS. 5-7 are schematic views illustrating processing of example LLM prompts.

### DESCRIPTION OF EXAMPLE EMBODIMENTS

### OVERVIEW

As previously mentioned, large language models may hallucinate and produce an output that is false, or that does not match the user's intent.

A common issue with LLMs is the misinterpretation of user queries, leading to incorrect category selection. This is especially prevalent when the available categories or functions have similar linguistic or contextual attributes, but differ significantly in their actual application or purpose, and may in practice, represent distinct concepts or functionalities within a system. Hallucination with respect to a categorization task may best be explained via an example.

Suppose that a bank has a chatbot to help customers, and the chatbot responds to the customers in the language used by the customers assuming that the language is a supported language. In this example, supported languages are English, Spanish Italian or French. A customer types the phrase “Si us plau, proporcioneu el meu saldo” to request the balance of their account. The language of the phrase is Catalan, an unsupported language. The chatbot sends a prompt to an LLM to identify the language of the phrase and may structure the prompt as follows:

“What is the language of the following sentence: “Si us plau, proporcioneu el meu saldo”? Respond with one of the following languages: English, Spanish Italian, or French, or return unknown if the language is not listed”.

The LLM may try to “please” the requestor and gravitate to the most similar, but incorrect, option available from the prompt. For example, the LLM may avoid responding that the language is not from list, and instead select Spanish as the answer, because Catalan is somewhat similar to Spanish, leading to an LLM hallucination, and the bank chatbot will communicate with the user in Spanish instead of informing the customer that their language is unsupported.

Another example is a technical support chatbot, which may operate using various application program interfaces (APIs). In this example, the chatbot supports the use of Incident-based APIs but not Alert-based APIs, and a user requests “set title of alert 118649 to test”. The technical support chatbot sends a prompt to an LLM to identify the correct API to address the user request and may structure the prompt as follows:

“Return the name of the API from the following list that is most suited to answer the request of “set title of alert 118649 to test”, or return unknown if not one of the below options:

SetIncidentData: Modifies a field(s) content for a specified incident….”

Similarly, the LLM may try to “please” the requestor and gravitate to the most similar, but incorrect, option available from the prompt. For example, the LLM may avoid responding that the API is not from list, and instead select SetIncidentData as the answer, because SetIncidentData is somewhat similar to setting an alert, leading to an LLM hallucination, and the technical support chatbot will try to make an API call with SetIncidentData instead of informing the user that their request is unsupported.

The conventional approach of adding more context or refining the LLM’s understanding does not always resolve this issue. This misinterpretation leads to incorrect category selection and possibly incorrect API calls, resulting in inaccurate responses or system behaviors that do not align with the user's original intent. The challenge arises when these systems incorrectly map queries to similar but incorrect categories or functions due to linguistic or contextual similarities.

Embodiments of the present disclosure address the problem of hallucinations related to a categorization task by generating prompts which include, in addition to given or “real” categories, decoy or “fake” categories to allow an LLM to gravitate to one of the decoy categories (if that is the correct answer to the categorization task) and avoid incorrectly selecting one of the “real” categories and thereby allow the LLM to provide a more accurate response for a categorization task. The decoy categories are closely aligned linguistically with potential user queries, but do not correspond to actual categories, but serve as a bait for the LLM's interpretation accuracy. When a system selects one of these fake options, it signals a misinterpretation, indicating that none of the real options are suitable for the query.

In the bank chatbot example cited above, the prompt may be generated with “real” categories corresponding to supported languages such as English, Spanish Italian, or French, and decoy categories corresponding to unsupported languages such as Albanian, Catalan, and Russian, and so on. In this example, the prompt may state “What is the language of the following sentence: “Si us plau, proporcioneu el meu saldo”? Respond with one of the following languages or return unknown if the language is not listed: English, Spanish Italian, French, Albanian, Catalan, and Russian…”. The LLM will then gravitate towards the correct category of Catalan and the bank chatbot may inform the customer that the language is unsupported.

In the technical support example cited above, the prompt may be generated with “real” categories corresponding to supported APIs such as SetIncidentData, and decoy categories corresponding to unsupported APIs such as SetAlertData, and so on. In this example the prompt may state “Return the name of the API from the following list that is most suited to answer the request of “set title of alert 118649 to test”, or return unknown if not one of the below options: SetIncidentData: Modifies a field(s) contents for a specified incident…. SetAlertData: Modifies a field(s) content for a specified alert……”. The LLM will then gravitate towards the correct category of SetAlertData and the technical support chatbot may inform the user that the request is unsupported.

Embodiments of the present disclosure provide enhanced precision in API matching. Traditional approaches rely heavily on refining the language model's understanding or adding more contextual information to improve API selection accuracy. However, these methods often fall short when dealing with nuanced differences in user intent. The introduction of fake APIs provides a direct and effective way to capture these subtle distinctions, ensuring a more precise alignment between user queries and API functionalities.

### SYSTEM DESCRIPTION

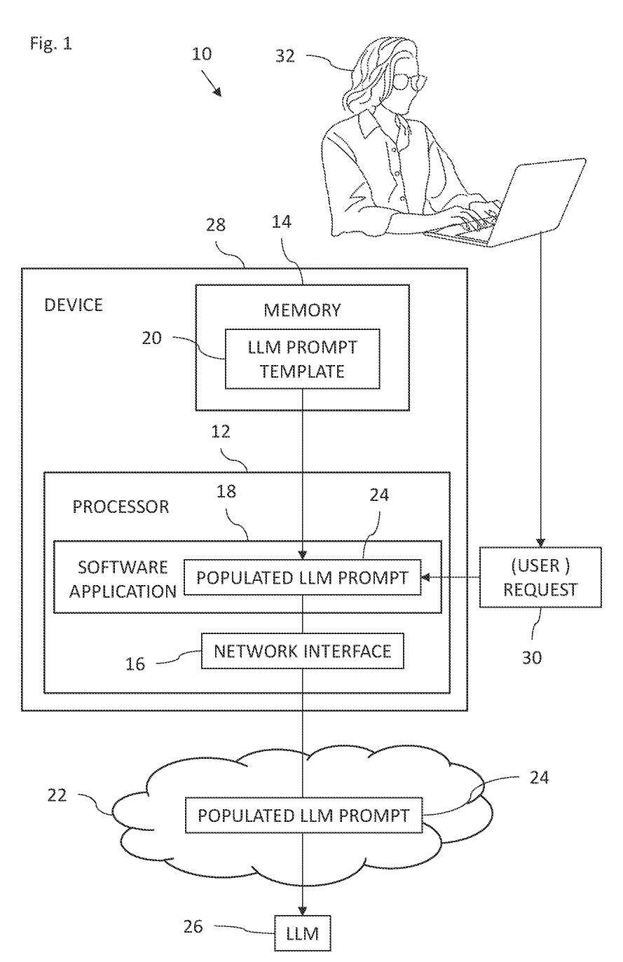

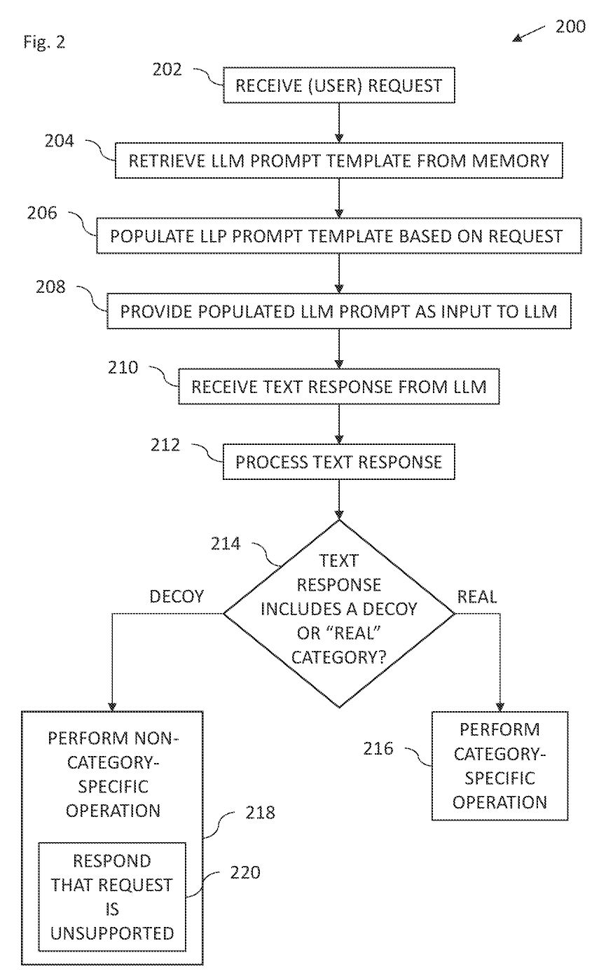

Reference is now made to FIGS. 1 and 2. FIG. 1 is a partly pictorial, partly block diagram view of an LLM-based computer system 10 constructed and operative in accordance with an embodiment of the present disclosure. FIG. 2 is a flowchart 200 including steps in a method of operation for use in the system 10 of FIG. 1. The LLM-based computer system 10 includes a device 28 (e.g., a processing device) including a processor 12, memory 14, and network interface 16. The processor 12 is configured to execute a software application 18, e.g., a chatbot-type application. The memory 14 is configured to store data used by the processor 12 including an LLM prompt template 20. The network interface 16 is configured to share data with one or more remote devices over a network 22, for example, to send a populated LLM prompt 24 to an LLM 26 running on a remote server. In some embodiments, the LLM 26 may be running in device 28. The software application 18 running on processor 12 is configured to receive a request 30 (e.g., user request) from a user 32 or any suitable entity, such as another device (block 202). The software application 18 running on processor 12 is configured to retrieve LLM prompt template 20 from memory 14 (block 204).

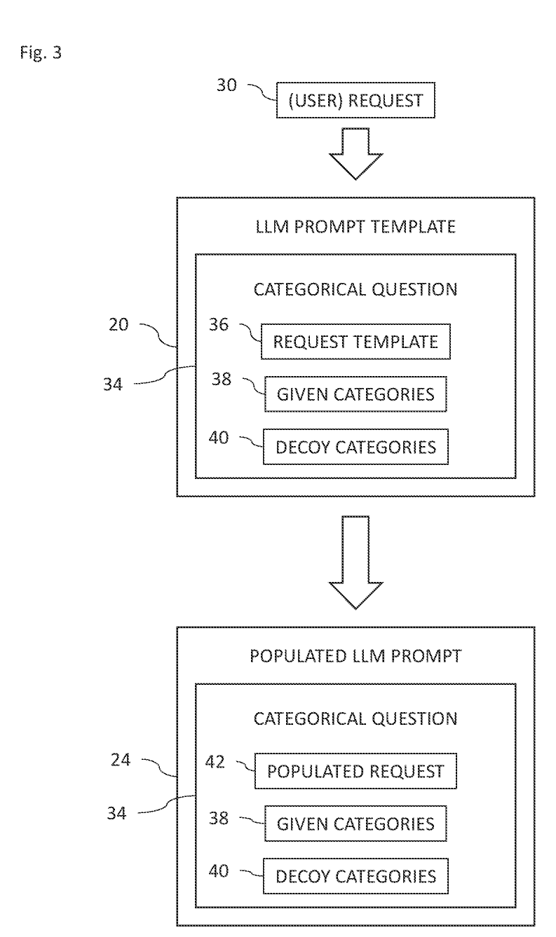

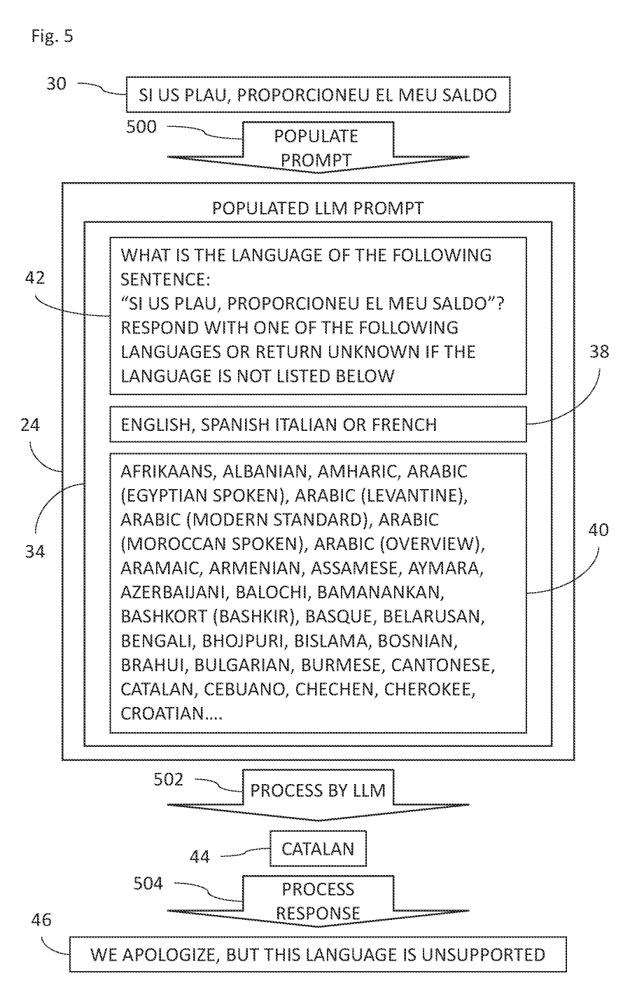

Reference is now made to FIG. 3, which is a schematic view illustrating population of LLM prompt template 20 for use in the system 10 of FIG. 1. Reference is also made to FIG. 2. The LLM prompt template 20 is setup to be populated in order to provide a categorical question 34 based on the request 30. The LLM prompt template 20 includes: a request template 36 which is updated based on the request 30; given categories 38 (e.g., “real” categories); and decoy categories 40 (e.g., “fake” categories). In some embodiments, the given categories 38 are categories that are supported by the software application 18 and the decoy categories 40 are categories that are unsupported by the software application 18. Examples of given “real” categories 38 and decoy categories 40 are provided with reference to FIGS. 5-7.

The software application 18 is configured to populate the LLM prompt template 20 yielding the populated LLM prompt 24 based on the request 30 (block 206). In some embodiments, the software application 18 is configured to amend the request template 36 of LLM prompt template 20 using request 30 to yield a populated request 42. For example, if the request template 36 is “WHAT IS THE LANGUAGE OF THE FOLLOWING SENTENCE: “<<INPUT-REQUEST>>”? RESPOND WITH ONE OF THE FOLLOWING LANGUAGES OR RETURN UNKNOWN IF THE LANGUAGE IS NOT LISTED BELOW:” and the request 30 is equal to “SI US PLAU, PROPORCIONEU EL MEU SALDO”, the populated request 42 will be equal to “WHAT IS THE LANGUAGE OF THE FOLLOWING SENTENCE: “SI US PLAU, PROPORCIONEU EL MEU SALDO”? RESPOND WITH ONE OF THE FOLLOWING LANGUAGES OR RETURN UNKNOWN IF THE LANGUAGE IS NOT LISTED BELOW”.

The populated LLM prompt 24 includes categorical question 34 for the LLM 26 to perform a categorization task. The categorical question 34 includes populated request 42, given categories 38, and decoy categories 40. Inclusion of the decoy categories 40 in the populated LLM prompt 24 causes the LLM 26 to avoid spuriously selecting one of the given categories 38.

Reference is again made to FIGS. 1 and 2. The software application 18 is configured to provide the populated LLM prompt 24 as input to the LLM 26 (block 208), e.g., over network 22.

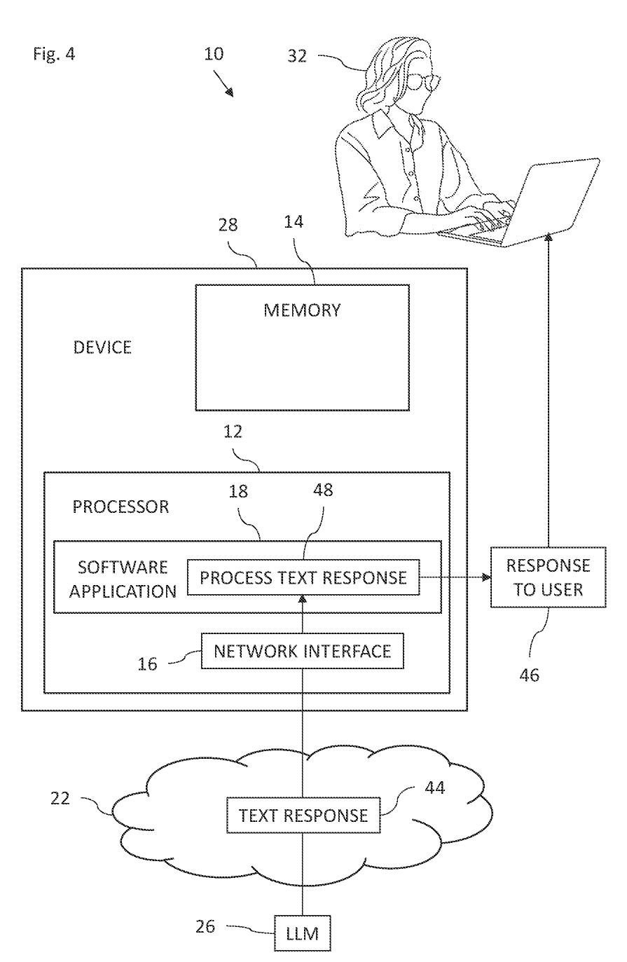

Reference is now made to FIG. 4, which is a partly pictorial, partly block diagram view of the LLM-based computer system 10 of FIG. 1 processing a text response 44 from LLM 26. Reference is also made to FIG. 2. The LLM 26 is configured to receive the populated LLM prompt 24 and process the populated LLM prompt 24 to yield text response 44. The LLM 26 is configured to provide the text response 44 to device 28 via network 22. The software application 18 running on processor 12 is configured to receive text response 44 from the LLM 26 based on LLM 26 processing the populated LLM prompt 24 as input (block 210). The text response 44 of the LLM 26 includes a categorical answer indicating one of the given categories 38 or one of the decoy categories 40. The software application 18 is configured to process text response 44 (block 48) to determine the next action(s) to be performed based on the text response 44 (block 212). The next action(s) may include the software application 18 providing a response 46 to user 32, for example.

At decision block 214, the software application 18 is configured to determine whether the text response 44 includes one of the given “real” categories 38 or one of the decoy categories 40.

If the text response 44 includes any one of the given “real” categories 38, the software application 18 is configured to perform a category-specific operation (i.e., an operation which is dependent on the selected given category 38) (block 216). For example, if the selected given category 38 is “ENGLISH”, then the software application 18 may proceed to communicate with user 32 in English, whereas if the selected given category 38 is “FRENCH”, then the software application 18 may proceed to communicate with user 32 in French. If the selected given category 38 is API 123, then the software application 18 may proceed to make an API call with API 123, whereas if the selected given category 38 is API 222, then the software application 18 may proceed to make an API call with API 222.

If the text response 44 includes any one of the decoy categories 40, the software application 18 may be configured to perform a non-category specific operation (and not perform a category-specific operation) and typically perform the same operation responsibly to any of the decoy categories 40 being selected by LLM 26 (block 218). In some embodiments, particularly, but not exclusively, when the decoy categories 40 correspond to unsupported categories, the software application 18 is configured to respond indicating that the request 30 is unsupported, based on any one of the decoy categories 40 being included in the text response 44 of the LLM 26 (block 220).

For example, for any decoy category 40, whether the decoy category is “CATALAN” or “ALBANIAN” etc., the software application 18 may provide a message that the language is unsupported. For example, for any decoy category, whether the decoy category is API 345 or API 456, the software application 18 may provide a message that the request is unsupported, or a similar generic phrase.

In practice, some, or all of the functions of processor 12 may be combined in a single physical component or, alternatively, implemented using multiple physical components. These physical components may comprise hard-wired or programmable devices, or a combination of the two. In some embodiments, at least some of the functions of processor 12 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIGS. 5-7 are schematic views illustrating processing of example LLM prompts 24.

FIG. 5 shows that the user 32 (FIG. 1) has provided request 30 asking for their bank balance in Catalan. The software application 18 populates (block 500) LLM prompt template 20 (FIG. 3) by adding the request 30 to request template 36 (FIG. 3) yielding populated request 42 in populated LLM prompt 24 as shown in FIG. 5. The populated LLM prompt 24 also includes given categories 38 which are languages supported by software application 18, and decoy categories 40 which are languages unsupported by software application 18. The populated LLM prompt 24 is processed by LLM 26 (block 502) to yield text response 44 including one of the decoy categories 40, e.g., “Catalan”. The software application 18 is configured to process (block 504) text response 44 and respond (e.g., to user 32) with response 46 indicating that the language of the request 30 is unsupported, based any of the decoy categories 40 (e.g., Catalan) being included in the text response 44 of the LLM 26.

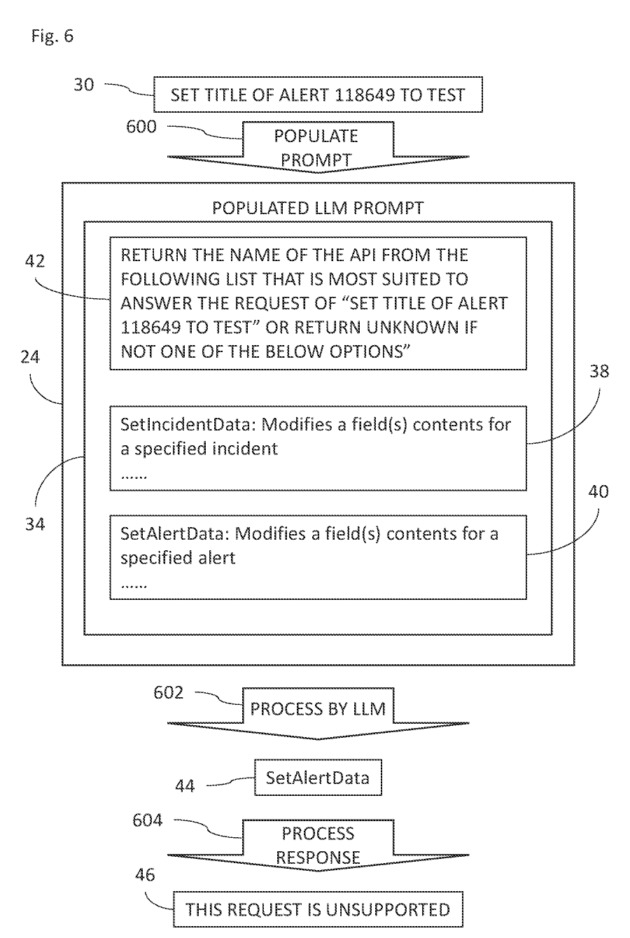

FIG. 6 shows that a request 30 has been made to set the title of alert 118649 to “test”. The software application 18 populates (block 600) LLM prompt template 20 (FIG. 3) by adding the request 30 to request template 36 (FIG. 3) yielding populated request 42 in populated LLM prompt 24 as shown in FIG. 6. The populated LLM prompt 24 also includes given categories 38 which are APIs supported by software application 18, and decoy categories 40 which are APIs unsupported by software application 18. Descriptions of the APIs are also included in populated LLM prompt 24. The populated LLM prompt 24 is processed by LLM 26 (block 602) to yield text response 44 including one of the decoy categories 40, e.g., “SetAlertData” API. The software application 18 is configured to process (block 604) text response 44 and respond (e.g., to user 32) with response 46 indicating that the request 30 is unsupported, based any of the decoy categories 40 (e.g., “SetAlertData”) being included in the text response 44 of the LLM 26.

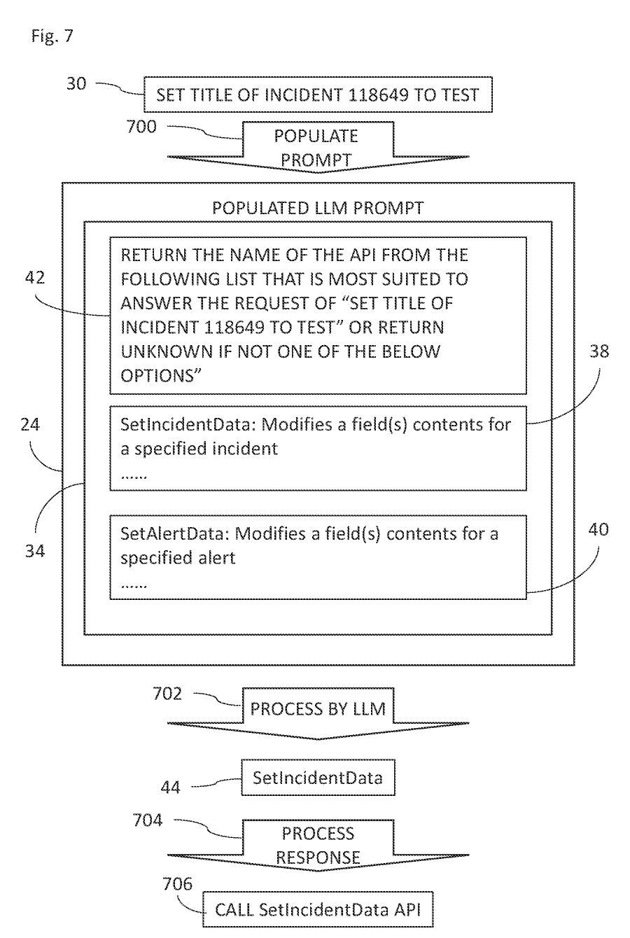

FIG. 7 shows that a request 30 has been made to set the title of incident 118649 to “test”. The software application 18 populates (block 700) LLM prompt template 20 (FIG. 3) by adding the request 30 to request template 36 (FIG. 3) yielding populated request 42 in populated LLM prompt 24 as shown in FIG. 7. The populated LLM prompt 24 also includes given categories 38 which are APIs supported by software application 18, and decoy categories 40 which are APIs unsupported by software application 18. Descriptions of the APIs are also included in populated LLM prompt 24. The populated LLM prompt 24 is processed by LLM 26 (block 702) to yield text response 44 including one of the given “real” categories 38, e.g., “SetIncidentData” API, so that the categorical answer indicates the category of a supported API. The software application 18 is configured to process (block 704) text response 44 and call the supported API included in text response 44 (block 706).

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A device, comprising:
a processor configured to execute a software application to:
populate a large language model (LLM) prompt template yielding a populated LLM prompt including a categorical question for an LLM to perform a categorization task, the categorical question including given categories and decoy categories;
provide the populated LLM prompt as input to the LLM; and
receive a text response from the LLM based on processing the populated LLM prompt as input, the text response of the LLM including a categorical answer indicating one of the given categories or one of the decoy categories; and
a memory to store data used by the processor.

2. The device according to claim 1 , wherein the software application is configured to:
perform a category-specific operation based on any one of the given categories being selected by the LLM; and
not perform a category-specific operation based on any one of the decoy categories being selected by the LLM.

3. The device according to claim 1, wherein inclusion of the decoy categories in the populated LLM prompt causes the LLM to avoid spuriously selecting one of the given categories.

4. The device according to claim 1, wherein:
the given categories are categories that are supported by the software application; and
the decoy categories are categories that are unsupported by the software application.

5. The device according to claim 4, wherein the software application is configured to respond indicating that a request is unsupported based on any one of the decoy categories being included in the text response of the LLM.

6. The device according to claim 4, wherein the software application is configured to respond indicating that a language of a request is unsupported based on any one of the decoy categories being included in the text response of the LLM.

7. The device according to claim 4, wherein the given categories are languages that are supported by the software application and the decoy categories are languages that are unsupported by the software application.

8. The device according to claim 4, wherein:
the given categories are supported Application Programming Interfaces (APIs); and
the decoy categories are unsupported APIs.

9. The device according to claim 8, wherein:
the categorical answer indicates one of the given categories of a given API of the supported APIs; and
the software application is configured to call the given API.

10. A method, comprising:
populating a large language model (LLM) prompt template yielding a populated LLM prompt including a categorical question for an LLM to perform a categorization task, the categorical question including given categories and decoy categories;
providing the populated LLM prompt as input to the LLM; and
receiving a text response from the LLM based on processing the populated LLM prompt as input, the text response of the LLM including a categorical answer indicating one of the given categories or one of the decoy categories.

11. The method according to claim 10, further comprising:
performing a category-specific operation based on any one of the given categories being selected by the LLM; and
not performing a category-specific operation based on any one of the decoy categories being selected by the LLM.

12. The method according to claim 10, wherein inclusion of the decoy categories in the populated LLM prompt causes the LLM to avoid spuriously selecting one of the given categories.

13. The method according to claim 10, wherein:
the given categories are categories that are supported by a software application; and
the decoy categories are categories that are unsupported by the software application.

14. The method according to claim 13, further comprising responding indicating that a request is unsupported based on any one of the decoy categories being included in the text response of the LLM.

15. The method according to claim 13, further comprising responding indicating that a language of a request is unsupported based on any one of the decoy categories being included in the text response of the LLM.

16. The method according to claim 13, wherein the given categories are languages that are supported by the software application and the decoy categories are languages that are unsupported by the software application.

17. The method according to claim 13, wherein:
the given categories are supported Application Programming Interfaces (APIs); and
the decoy categories are unsupported APIs.

18. The method according to claim 17, wherein the categorical answer indicates one of the given categories of a given API of the supported APIs, the method further comprising calling the given API.

19. A software product, comprising a non-transient computer-readable medium in which program instructions are stored, which instructions, when read by a central processing unit (CPU), cause the CPU to:
populate a large language model (LLM) prompt template yielding a populated LLM prompt including a categorical question for an LLM to perform a categorization task, the categorical question including given categories and decoy categories;
provide the populated LLM prompt as input to the LLM; and
receive a text response from the LLM based on processing the populated LLM prompt as input, the text response of the LLM including a categorical answer indicating one of the given categories or one of the decoy categories.
